(19) United States
(12) Patent Application Publication
(10) Pub. No.: US 2017/0182923 A1
(43) Pub. Date: Jun. 29, 2017

(54) HEAVY-DUTY TRANSPORT VEHICLE FOR CONTAINERS, IN PARTICULAR ISO CONTAINERS, AND METHOD FOR LOADING SAME

(71) Applicant: Terex MHPS GmbH, Düsseldorf (DE)

(72) Inventors: Mike HEGEWALD, Düsseldorf (DE); Armin WIESCHEMANN, Oberhausen (DE); Jannis MOUTSOKAPAS, Monheim (DE)

(21) Appl. No.: 15/324,065

(22) PCT Filed: Jul. 6, 2015
(86) PCT No.: PCT/EP2015/065386

§ 371 Date: Jan. 5, 2017

(30) Foreign Application Priority Data
Jul. 10, 2014 (DE) 10 2014 109 700.9

(51) Int. Cl. B60P 1/64; B60P 3/40

(52) U.S. Cl. CPC B60P 1/649; B60P 3/40

(57) ABSTRACT

A heavy-duty transport vehicle for containers, in particular ISO containers, which moves freely on floors, not on rails, and has a loading surface on which a first container can be placed, as well as a method for loading the same. A second container can be placed on the first container to provide increased transport capacity, with the heavy-duty transport vehicle comprising at least one guidance system for guiding the second container, such as the bottom fittings thereof, when the second container is placed on the first container, such as onto the top fittings thereof.

The present application claims the priority benefits of International Patent Application No. PCT/EP2015/065386, filed Jul. 6, 2015, and claims benefit of DE 102014109700.9, filed on Jul. 10, 2014.

### BACKGROUND OF THE INVENTION

The invention relates to a heavy-duty transport vehicle for containers, in particular ISO containers, which is freely movable on floors, and rail-bound, and has a loading surface on which a first container can be placed.

The invention also relates to a method for loading such a heavy-duty transport vehicle.

A typical field of application of such heavy-duty transport vehicle is handling installations for containers, in particular standardised ISO containers, and in this case in particular the transport of containers within container terminals at seaports or inland ports as well as in container terminals for combined traffic between road and rail.

In this connection, ISO containers are understood to be standardised large-capacity containers or sea freight containers comprising standardised picking-up points or corner fittings for load picking-up means, which are used in international goods traffic. The most widely used are ISO containers having a width of 8 foot and a length of 20, 40 or 45 foot.

A corresponding heavy-duty transport vehicle can transport a payload of at least 20 t. A 40 foot long ISO container can weigh up to 35 tin the laden state. A heavy-duty transport vehicle which travels without a load or transports an empty ISO container is also included in this definition, insofar as this vehicle is able to transport a payload of at least 20 t.

Such heavy-duty transport vehicles typically have pneumatic rubber tyres and are thereby floor-bound but not rail-bound and thus are freely movable. Accordingly, the heavy-duty transport vehicles concerned in the present case are to be differentiated from rail vehicles and in particular from freight cars. Furthermore, the heavy-duty transport vehicles can be operated manually by a driver travelling in a driver's cab, semi-automatically or, in the case of so-called Automated Guided Vehicles (AGV) which do not have a driver's cab, can be operated fully automatically and therefore without a driver. The drive of these heavy-duty transport vehicles is typically diesel-electric, diesel-hydraulic or fully electric.

Heavy-duty transport vehicles which correspond to one of the previously described types are known e.g. from German laid-open document DE 10 2009 025 051 A1.

Furthermore, European patent application EP 323 394 A1 discloses a transport vehicle, by means of which a plurality of empty containers can be transported at the same time. For this purpose, the containers which are positioned next to one another and/or on top of one another beforehand are connected, prior to being transported, with their corner fittings by means of so-called twistlocks to form a transport unit and subsequently are placed on a loading surface of the transport vehicle.

U.S. Pat. No. 4,784,548 A discloses a freight car which is movable on rails and on whose loading surface a first container can be placed. The freight car comprises a frame-like support structure which extends, next to the loading surface or storage surface for the first container, vertically upwards away from the loading surface and on which a second container can be placed above the first container. The support structure has, in the region of its corners, carrying elements by means of which the second container can be picked up and carried with its container corners.

### SUMMARY OF THE INVENTION

The object of the present invention is to provide an improved heavy-duty transport vehicle for containers, in particular ISO containers, having increased transport capacity, and to provide a method for loading same.

A heavy-duty transport vehicle for containers, in particular ISO containers, which is freely movable on floors and not rail-bound and has a loading surface on which a first container can be placed is improved by virtue of the fact that a second container can be placed on the first container and the heavy-duty transport vehicle has at least one guide for guiding the second container, in particular the bottom corner fittings thereof, when it is placed on the first container, in particular on the top corner fittings thereof. The guide advantageously ensures that when the second container is placed on the lower first container the bottom corner fittings of the upper second container are positioned simply and rapidly on the corresponding top corner fittings of the lower first container and are aligned congruently with one another. The guide serves at the same time to secure the placed upper second container during transport journeys. In particular, the corner fittings arranged one on top of the other are prevented in this case from slipping exclusively by means of the guide, so that the corner fittings do not require any additional connection, e.g. by means of twistlocks. Therefore, the transport volume of the heavy-duty transport vehicle can be increased whilst maintaining the same travel time and adhering to the same travel route.

In a structurally simple manner, provision is made that the guide can be moved between a loading position and a release position by means of a positioning apparatus.

Precise guidance and securing during placement or a secure unloading procedure of the second container is achieved in a simple manner by virtue of the fact that in the loading position the guide lies against the first container, preferably against a top corner fitting of the first container, and in the release position the guide is arranged spaced apart from the first container.

Dimensional tolerances and loading inaccuracies of the first container can be advantageously compensated for by virtue of the fact that the guide is mounted on at least one positioning arm of the positioning apparatus, said positioning arm being mounted on the heavy-duty transport vehicle so as to be movable in a translatory or rotatory manner, preferably in a longitudinal direction of the heavy-duty transport vehicle, between the loading position and the release position.

The positioning apparatus moves in a simple manner by virtue of the fact that the positioning apparatus has a positioning drive by means of which the positioning apparatus, in particular the positioning arm, can be moved.

In a structurally simple manner, provision is made that the positioning drive is designed as a linear drive and preferably comprises a belt drive, chain drive, rack and pinion drive or a lifting cylinder, in particular an electric cylinder or hydraulic cylinder, arranged underneath the loading surface.

The containers are guided and secured in a reliable and structurally simple manner by virtue of the fact that the guide has a first guide surface and a second guide surface, in the loading position the first guide surface lies against a head side of the first container and/or the second guide surface lies against a longitudinal side of the first container, preferably against a top corner fitting of the first container.

Flexible use in relation to different container heights is advantageously achieved by virtue of the fact that in the loading position the first guide surface and the second guide surface extend over a height at which the top corner fittings of any container placed on the loading surface, in particular an ISO container with a container height of 8 foot to 9 foot, 6 inches, are arranged and preferably in the loading position the first guide surface is oriented in parallel in relation to the head side and the second guide surface is oriented in parallel in relation to the longitudinal side.

By virtue of the fact that adjoining above the first guide surface and above the second guide surface is a respective insertion sleeve which in the loading position extends in each case obliquely upwards and in a manner directed away from the container, a container oscillating to a greater extent during lowering can be grasped and captured by the guides, in particular the insertion surfaces. This simplifies and speeds up the loading procedure.

In a structurally simple manner, provision is also made that each guide is mounted in a rotatable manner, in particular oscillating about an axis of oscillation oriented transversely, preferably horizontally, with respect to a longitudinal direction of the heavy-duty transport vehicle, or in a rotationally fixed manner on the at least one positioning arm. In particular, in the case of a rotationally movable positioning arm and guides mounted in an articulated manner about the axis of oscillation, the compensation of dimensional tolerances and loading inaccuracies can be improved further by reason of the guides which can be moved in a circular path from the release position to the loading position.

In an advantageous manner, the reliability can be increased further by virtue of the fact that the guide is mounted in a rotatable manner such that the guide surfaces are oriented vertically in each position of the guide, in particular in each position of the guide deviating from the loading position.

In a structurally simple manner, the reliability is further increased by virtue of the fact that the guide has two stops in the region of the axis of oscillation, in order to limit oscillation of the guide about the axis of oscillation.

Particularly reliable guidance and securing for transport journeys is achieved by virtue of the fact that two guides are arranged at a first end and/or two guides are arranged at a second end of the heavy-duty transport vehicle such that in the loading position in each case one of the guides lies at the first end and/or at the second end against each of the top corner fittings of the first container.

In a structurally simple manner, provision is made that the two guides are each connected to one another at the first end and/or the two guides are each connected to one another at the second end, preferably mounted on a transverse beam, and can be moved in a synchronised manner by means of the at least one positioning arm.

As an alternative, provision is made in a structurally simple manner that each guide is rotatably mounted on two positioning arms which are coupled to one another in the manner of a parallelogram guide and are mounted so as to be movable in a synchronised manner via the positioning drive.

In an advantageous manner, provision is made that the heavy-duty transport vehicle is designed as an automated guided vehicle.

A method for loading a corresponding heavy-duty transport vehicle, wherein in a first loading step the first container is placed on the loading surface, is improved by virtue of the fact that during the first loading step each guide is arranged in the release position and after the first container has been placed each guide is moved to the loading position. As a result, the lower first container is additionally secured even if a second container is not placed on the first container.

Particularly secure and precise loading of the heavy-duty transport vehicle for so-called double-stack transportation is achieved by virtue of the fact that in a second loading step the second container is placed on the first container and in this case the second container, in particular the bottom corner fittings thereof, is guided via at least one guide onto the first container, in particular onto the top corner fittings thereof. With regard to the method, the advantages already set forth in relation to the heavy-duty transport vehicle are likewise achieved.

An exemplified embodiment of the invention is explained in greater detail with the aid of the following description of the drawings.

### BRIEF DESCRIPTION OF THE DRAWINGS

FIG. 1a shows a perspective view of a first embodiment of a heavy-duty transport vehicle,

FIG. 1b shows a side view of the heavy-duty transport vehicle shown in FIG. 1a,

FIGS. 2a and 2b show a further side view of the heavy-duty transport vehicle shown in FIG. 1a in various loading situations,

FIGS. 3a and 3b show a side view of a second embodiment of the heavy-duty transport vehicle in various loading situations,

FIGS. 4a and 4b show a side view of a third embodiment of the heavy-duty transport vehicle in various loading situations, and

FIGS. 5a and 5b show a side view of a fourth embodiment of the heavy-duty transport vehicle in various loading situations.

### DESCRIPTION OF THE PREFERRED EMBODIMENTS

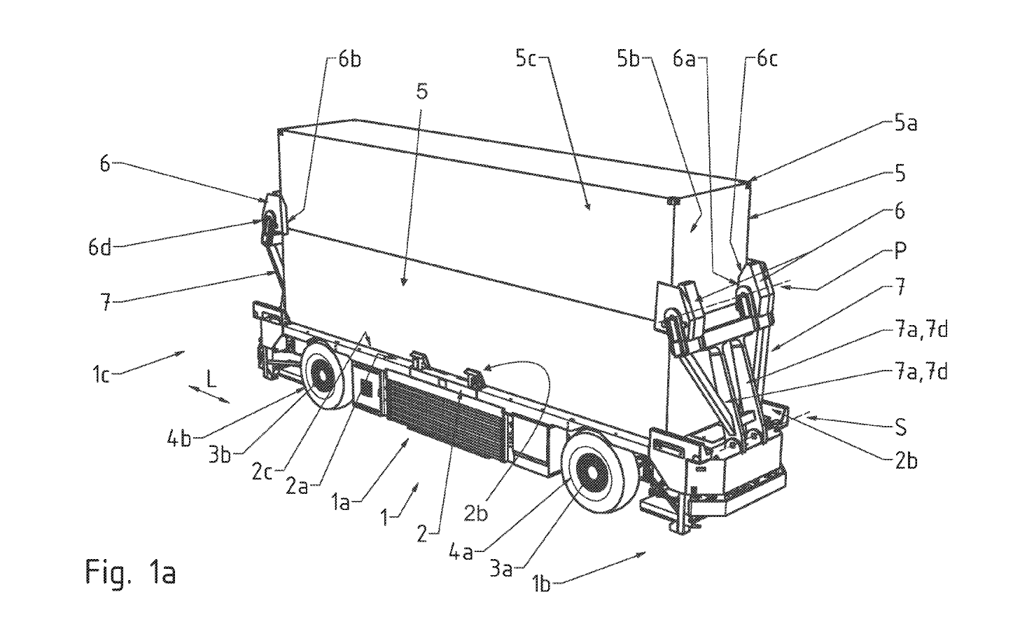

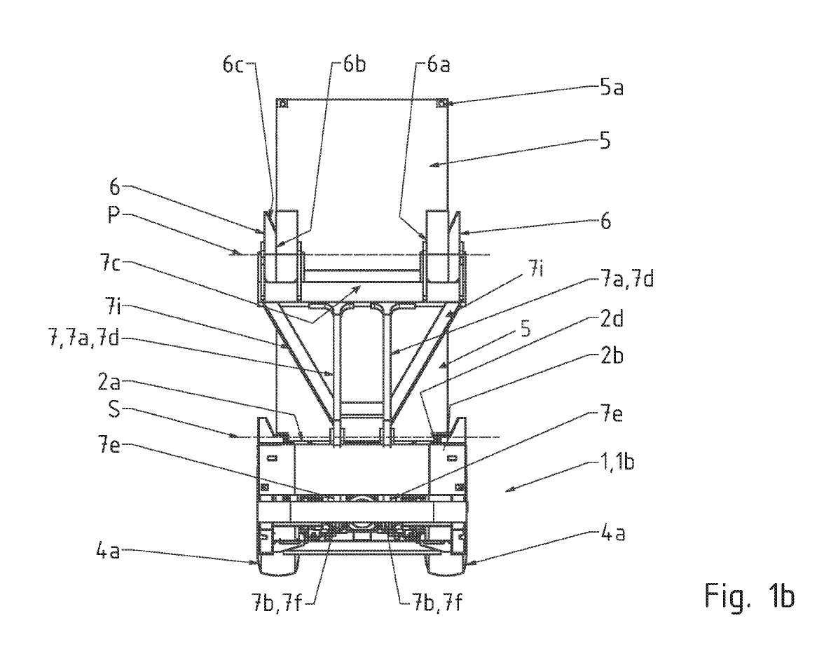

FIG. 1a shows a perspective view of a floor-bound and automated heavy-duty transport vehicle 1 for containers 5, in particular ISO containers, in the manner of an AGV without a driver's cab. The heavy-duty transport vehicle 1 which is designed as a four-wheel vehicle consists substantially of a vehicle frame 2, on which two front wheels 4a are mounted on a common front axle 3a and two rear wheels 4b are mounted on a common rear axle 3b. The four wheels 4a, 4b are provided with tyres which are preferably pneumatic rubber tyres. The wheels 4a allow the floor-bound heavy-duty transport vehicle 1 to move freely, and accordingly not rail-bound.

Moreover, the heavy-duty transport vehicle 1 comprises a travel drive which consists substantially of a front electric motor, a front transfer gear-box, a rear electric motor and a rear transfer gear-box. The front electric motor, as seen in the longitudinal direction L of the heavy-duty transport vehicle 1, is attached centrally and in the region of the front axle 3a underneath the vehicle frame 2. The rear electric motor, as seen in the longitudinal direction L of the heavy-duty transport vehicle 1, is attached centrally and in the region of the rear axle 3b underneath the vehicle frame 2. The front electric motor drives the two front wheels 4a via the front transfer gear-box and the rear electric motor drives the two rear wheels 4b via the rear transfer gear-box. Therefore, the heavy-duty transport vehicle 1 has an all-wheel drive system. The travel drive can be of a diesel-electric design or a fully electric design comprising a battery, in particular a lead battery.

The vehicle frame 2 supports a planar loading surface 2a for placing at least one container 5 which is to be transported. However, the heavy-duty transport vehicle 1 is designed in such a manner that a double stack of 40 or 45 foot long containers 5 or in principle even one or two double stacks of 20 foot long containers 5 can be transported, wherein the containers 5 can each be loaded to the maximum extent. It is also fundamentally possible to form a stack comprising two lower 20 foot long containers 5, which are placed one behind the other directly on the loading surface 2a, and one 45 foot long container 5 which is placed thereon. Accordingly, the heavy-duty transport vehicle 1 is designed for a maximum payload of approximately 70 t.

The heavy-duty transport vehicle 1 illustrated in FIG. 1a is loaded with a lower first container 5, which is placed directly on the loading surface 2a, and an upper second container 5 which is placed thereon. In this case, the upper second container 5 is placed with its bottom corner fittings 5a, which are also defined as corner castings, on corresponding top corner fittings 5a of the lower first container 5. The corner fittings 5a which are allocated to one another in this manner are not connected to one another, in particular not by means of so-called twistlocks. Both containers 5 are 40 foot long ISO containers. However, the loading surface 2a is dimensioned in such a manner that also one 45 foot long container 5 or two 20 foot long containers 5 one behind the other and oriented with their longitudinal extension in the longitudinal direction L can be placed and, as described hereinafter, corresponding double stacks can be formed.

A plurality of guide elements 2b which are defined as position adapters are arranged on the loading surface 2a, in order to define, on the loading surface 2a, a substantially rectangular storage surface 2c for the lower first container(s) 5. In this case, the guide elements 2b are arranged circumferentially in the manner of a wall in an edge region of the loading surface 2a and are arranged spaced apart from one another. Starting from their attachment to the loading surface 2a, all of the guide elements 2b extend obliquely upwards and outwards. By virtue of this funnel-like arrangement, the guide elements 2b serve as a guide or stop when a container 5 is placed on the loading surface 2a. A container 5 which, whilst being lowered by a crane, oscillates in a manner suspended from the load picking-up means thereof, e.g. in the form of a so-called spreader, and therefore must be oriented with respect to the storage surface 2c, stops in particular with its bottom corner fittings 5a initially against the guide elements 2b, is oriented therewith and is guided onto the storage surface 2c as it is lowered further. Moreover, the guide elements 2b serve to secure containers 5 placed directly on the loading surface 2a to prevent them from slipping transversely with respect to the longitudinal direction L. Moreover, in order to secure containers 5 on the loading surface 2a, securing elements 2d (see FIG. 1b) are provided which prevent the container 5 from slipping in the longitudinal direction L. In order in this manner to be able to secure containers 5 of the aforementioned different container sizes, the securing elements 2d are arranged on the loading surface 2a spaced apart from one another in the manner of a grid.

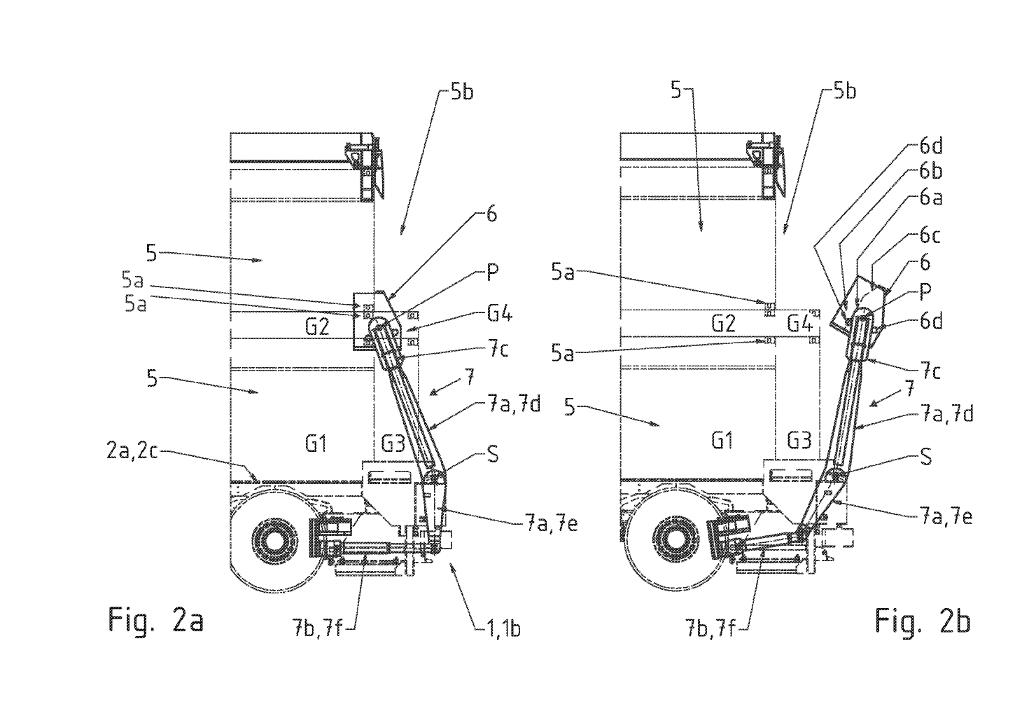

The heavy-duty transport vehicle 1 has two guides 6 in the region of its first end 1b as seen in the longitudinal direction L, in order to guide in particular the bottom corner fittings 5a of the upper second container 5, as said second container is being placed, onto the top corner fittings 5a of the lower first container 5. The two guides 6 can be moved together between a loading position (see FIGS. 1a, 1b and 2a) and a release position (see FIG. 2b) by means of a positioning apparatus 7. In the same manner, two further guides 6 and one further positioning apparatus 7 are arranged at the opposite second end 1c, so that a guide 6 is provided in each case for each of the four corner fittings 5a. The following statements relate to the first end 1b but apply similarly to the second end 1c.

In a first loading step, a first container 5 is placed onto the vacant loading surface 2a of the heavy-duty transport vehicle 1, wherein the positioning apparatus 7 and the guides 6 are located in the release position. In the release position, the guides 6 do not lie against the first container 5 but instead are arranged at least horizontally spaced apart therefrom. Irrespective of whether during the course of the procedure a second container 5 is set down on the first container 5 which is already loaded onto the loading surface 2a, or a transport journey is performed only with the first container 5, the guides 6 are moved from the release position to the loading position by the positioning apparatus 7 after the first container 5 has been placed. In the loading position which is illustrated in FIGS. 1a, 1b and 2a, each guide 6 lies against one of the top corner fittings 5a of the first container 5 which face towards the first end 1b. In this manner, the first container 5 is additionally secured to prevent slipping and the guides 6 and the positioning apparatus 7 are prevented from protruding beyond the vehicle outer contour.

In order, during unloading of the heavy-duty transport vehicle 1, to be able to raise and move the upper second container 5 away from the lower first 5 and to be able to raise and move the first container 5 itself away, the guides 6 are moved from the loading position back to the release position by the positioning apparatus 7.

The guides 6 form, for the second container 5 which is to be placed and is also 40 foot long—similar to the guide elements 2b for the lower first container 5—a type of stop which, as the second container 5 suspended from a spreader is lowered, limits the oscillating movements thereof in horizontal directions, in particular in the longitudinal direction L and transversely thereto. For this purpose, the guides 6 are designed as a type of angle profile-shaped guide shoes consisting in each case of a first guide block having a first guide surface 6a and of a second guide block having a second guide surface 6b. In the loading position, each guide 6 lies with the first guide surface 6a on a head side 5b of the lower first container 5 against an upper corner fitting 5a, wherein the first guide surface 6a extends in parallel with the head side 5b. The second guide surface 6b lies on a longitudinal side 5c of the lower first container 5 against the upper corner fitting 5a of the first container 5 and extends in parallel in relation to the longitudinal side 5c. By reason of the loading inaccuracies of the first container 5 and dimensional tolerances of the containers 5, it is possible that in the loading position only one guide or none of the guides 6 lies in position with the second guide surface 6b.

FIG. 1b shows a side view of the first end 1b of the heavy-duty transport vehicle 1 shown in FIG. 1a. FIG. 1b illustrates that the first guide surface 6a and the second guide surface 6b extend in the loading position over a height at which the top corner fittings 5a of any first container 5 placed on the loading surface 2a, in particular an ISO container with a container height of 8 foot to 9 foot, 6 inches, are arranged (see also FIG. 2b). The two guide surfaces 6a, 6b form in this manner an extended guide region which, irrespective of the container height of the lower first container 5, allows the top corner fittings 5a of said first container to lie against it and thus allows the upper second container 5 to be guided. At the same time, the guides 6 prevent the upper second container 5 from slipping, so that the guides 6 also serve to secure the second container 5 e.g. during a transport journey.

In order to thread the second container 5, which oscillates as it is lowered onto the first container 5, more simply into the region of the guide surfaces 6a, 6b which are vertical in the loading state, an insertion surface 6c adjoins in each case above the first guide surface 6a and above the second guide surface 6b. The insertion surfaces 6c extend in the loading position in each case obliquely upwards and in a manner directed away from the container 5, so that—similar to the guide elements 2b—a funnel-like arrangement of the insertion surfaces 6c is produced. The guides 6 together with their guide surfaces 6a, 6b and insertion surfaces 6c serve accordingly as a positioning aid, in order to position the second container 5, as it is being lowered, with its bottom corner fittings 5a in a precise manner on the top corner fittings 5a of the first container 5.

The two guides 6 are moved at the first end 1b in a synchronised manner between the loading position and the release position by means of the positioning apparatus 7. For this purpose, the two guides 6 are connected to one another by means of a horizontal transverse beam 7c, so that a type of one-piece guide is produced for the corner fittings 5a arranged at the first end 1b. At opposite ends of the transverse beam 7c, in each case one of the guides 6 is mounted in such a manner as to oscillate about an axis of oscillation P (see also FIG. 1a) oriented transversely and horizontally with respect to the longitudinal direction L of the heavy-duty transport vehicle 1. Each guide 6 has two stops 6b in the region of its axis of oscillation P, in order to limit oscillation of the guide 6 about the axis of oscillation P.

In order to move the guides 6 between the loading position and the release position, the guides 6 are mounted on two positioning arms 7a of the positioning apparatus 7. By virtue of the fact that the positioning arms 7a are each mounted rotatably on the first end 1b, preferably on the vehicle frame 2 in the region of the loading surface 2a, such that the positioning arms 7a can be moved in a rotatory manner about a swivel axis S oriented transversely and horizontally with respect to the longitudinal direction L of the heavy-duty transport vehicle 1, each positioning arm 7a forms a lever system. Starting from the swivel axis S, each positioning arm 7a accordingly has a first limb 7d forming the upper first lever of the lever system and a second limb 7e forming the lower second lever of the lever system. The first limb 7d forms with the second limb 7e an angle of less than 180 degrees, preferably approximately 150 to 170 degrees, particularly preferably approximately 160 degrees. The positioning arms 7a are mounted in particular spaced apart from one another in parallel, wherein the positioning arms 7a are connected to the transverse beam 7c at upper ends of the first limbs 7d above the vehicle frame 2. Below the vehicle frame 2, the positioning arms 7a are connected to a positioning drive 7b (see also FIGS. 2a and 2b) at lower ends of their second limbs 7e, in order to allow the positioning arms 7a and thus the guides 6 to move in a synchronised manner between the loading position and the release position. The positioning drive 7b is designed as a linear drive and comprises two lifting cylinders 7f, preferably electric cylinders or hydraulic cylinders, of which in each case one is drivingly and rotatably connected to the second limb 7e of a positioning arm 7a. In FIGS. 2a and 2b, the lifting cylinders 7f are designed as electric cylinders. It can also be the case that only one lifting cylinder 7f is drivingly connected to the positioning arms 7a. Of course, it is also feasible for only one positioning arm 7a to be provided which is connected to the positioning drive 7b and the transverse beam 7c. Furthermore, each end of the transverse beam 7c is supported on the corresponding positioning arm 7a via a brace 7i, wherein each brace 7i, extending diagonally, connects the respective end of the transverse beam 7c above the swivel axis S to the first limb 7d of the positioning arm 7a.

A further side view of the first end 1b of the heavy-duty transport vehicle 1 shown in FIG. 1a is shown in the loading position in FIG. 2a and in the release position in FIG. 2b. In particular, FIGS. 2a and 2b schematically illustrate various loading situations with possible examples of sizes G1 to G4 of the first container 5 and their positions on the loading surface 2a. In this case, G1 designates a first size of a 40 foot long container 5 with a container height of 8 foot, G2 designates a second size of a 40 foot long container 5 with a container height of 9 foot, 6 inches, G3 designates a third size of a 20 or 45 foot long container 5 with a container height of 8 foot and G4 designates a fourth size of a 20 or 45 foot long container 5 with a container height of 9 foot, 6 inches.

After the first container 5 of size G2 is guided and placed by the guide elements 2b onto the loading surface 2a or storage surface 2c in the first loading step, the preparation for the second loading step takes place, in that the guides 6 are moved to the loading position by the positioning apparatus 7 by means of extension of the lifting cylinders 7f of the positioning drive 7b and associated swivelling of the positioning arms 7a about the swivel axis S. In the second loading step, the second container 5 which is likewise 40 foot long is then placed on the first container 5 and in this case the second container 5 is guided onto the first container 5 via the guides 6. Even after the second container 5 has been already been placed, as shown in FIG. 2a, the guides 6 and the positioning apparatus 7 remain in the loading position, in order to secure the second container 5 to prevent it from slipping because the two containers 5 are not connected to one another by means of twistlocks. The guides 6 are moved to the loading position after the first container 5 has been placed even if no container stack is formed for double-stack transportation but instead only one lower first container 5 is to be transported.

In the release position shown in FIG. 2b, the positioning apparatus 7 has swivelled the guides 6 away from the first container 5 by retracting the lifting cylinders 7f and correspondingly swivelling the positioning arms 7a out of the loading position, so that the guides 6 are arranged spaced apart from the lower first container 5. As a result, the second container 5 is released and can be lifted from the first container 5. The guides 6 and the positioning apparatus 7 are likewise moved to the release position, in order to be able to place the lower first container 5 in the first loading step on the loading surface 2a. The first guide surfaces 6a of the guides 6 facing towards the head side 5b of the first container 5 are not oriented in parallel with the head side 5b or vertically by reason of the oscillating bearing of the guides 6 in the release position. Oscillation of the guides 6 about the axis of oscillation P is limited by the stops 6d.

As can be seen in FIGS. 2a and 2b, the guides 6 and the positioning apparatus 7 are designed such that in the release position 20 or 45 foot long containers 5 can also be placed on the loading surface 2a and in the loading position the guides 6 can lie against lower first containers 5 of all sizes G1, G2, G3 or G4.

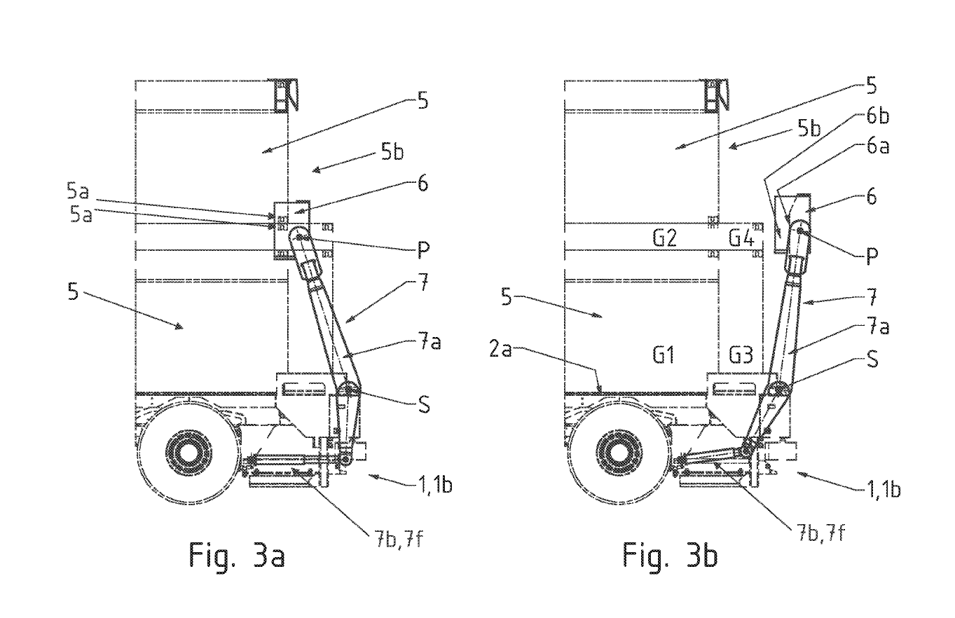

FIGS. 3a and 3b illustrate a side view of a second embodiment of the first end 1b of the heavy-duty transport vehicle 1 in the loading situations shown in FIGS. 2a and 2b. The second embodiment differs from the first embodiment in that the guides 6 are mounted, in relation to their centres of gravity, in a rotatable manner on the positioning arms 7a such that the guide surfaces 6a, 6b are oriented vertically in each position of the respective guide 6, in particular in each position of the guide 6 deviating from the loading position (FIG. 3a), such as e.g. the release position (FIG. 3b). Accordingly, no stops 6d are required. In the second embodiment illustrated in FIGS. 3a and 3b, the lifting cylinders 7f are formed as hydraulic cylinders by way of example.

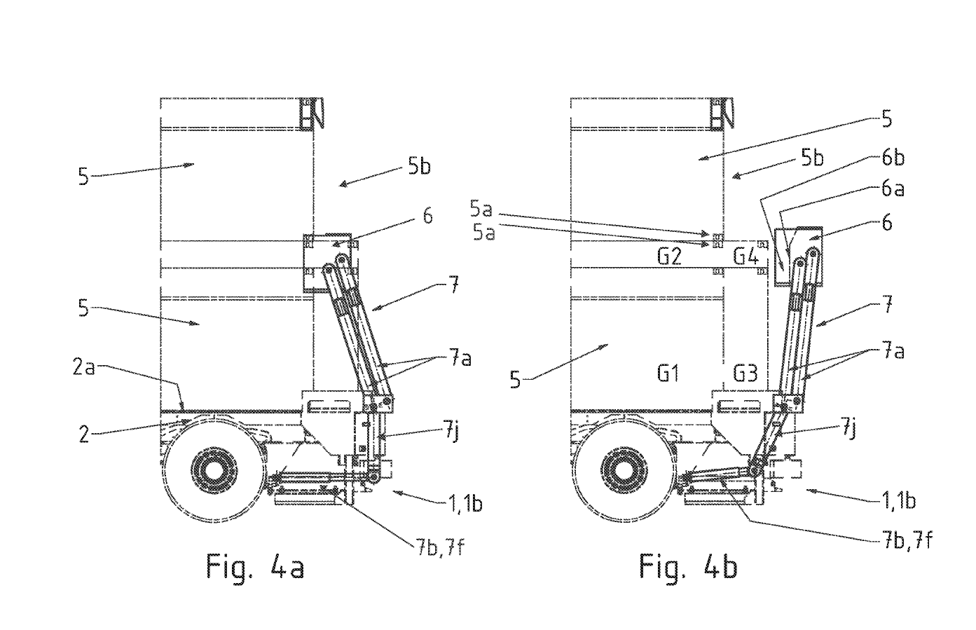

FIGS. 4a and 4b illustrate a side view of a third embodiment of the first end 1b of the heavy-duty transport vehicle 1 in the loading situations shown in FIGS. 2a and 2b. The third embodiment differs from the first embodiment in that the positioning drive 7 comprises two positioning arms 7a which are coupled to one another in the manner of a parallelogram guide and are rotatably mounted on the vehicle frame 2 in the region of the loading surface 2a. In this case, each of the guides 6 is rotatably mounted directly on two positioning arms 7a. In this manner, the positioning arms 7a connected to the positioning drive 7b in each case by a drive lever 7j can be moved in a synchronised manner such that the guide surfaces 6a, 6b are oriented vertically, as in the second embodiment, in each position, in particular in the loading position (FIG. 4a) and in the release position (FIG. 4b). In order to stiffen the positioning apparatus 7, two guides 6 can also be connected to one another by means of a horizontal transverse beam 7c (not illustrated in FIGS. 4a and 4b), so that the positioning apparatus 7 comprises a total of two parallelogram guides. Alternatively, each guide 6 can be mounted via two parallelogram guides.

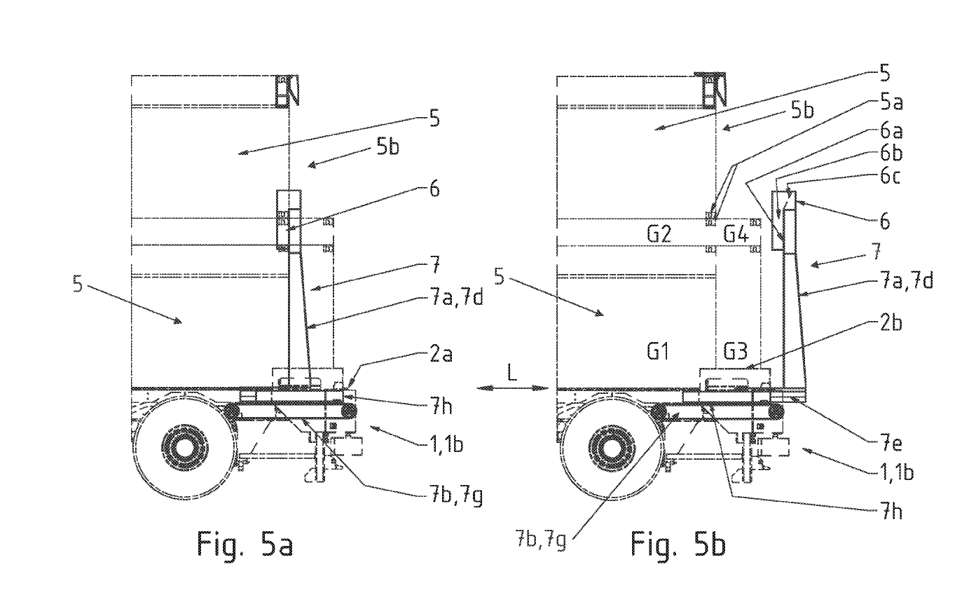

FIGS. 5a and 5b illustrate a side view of a fourth embodiment of the first end 1b of the heavy-duty transport vehicle 1 in the loading situations shown in FIGS. 2a and 2b. The fourth embodiment differs from the first three embodiments in that the positioning arms 7a are mounted on the heavy-duty transport vehicle 1 such that the positioning arms 7a can be moved in a translatory manner in the longitudinal direction L of the heavy-duty transport vehicle 1 between the loading position (FIG. 5a) and the release position (FIG. 5b). In this case, the guides 6 are mounted in a rotationally fixed manner on the vertically extending first limbs 7d of the positioning arms 7a, so that the first and second guide surfaces 6a and 6b are oriented vertically in each position of the respective guide 6, in particular in each position of the guide 6 deviating from the loading position. The limbs 7d, 7e of the positioning arms 7a are arranged correspondingly in an L-shape at an angle of approximately 90 degrees with respect to one another, wherein the horizontally extending second limbs 7e can be moved preferably below the loading surface 2a along a linear guide 7h in the longitudinal direction L. For this purpose, the positioning drive 7b which is connected to the second limbs 7e is likewise designed as a linear drive which comprises a belt drive 7g and is coupled to the positioning arms 7a such that a corresponding linear movement is diverted. Instead of the belt drive 7g, e.g. a chain drive, rack and pinion drive or a lifting cylinder, preferably an electric cylinder or hydraulic cylinder, can also be used.

The guides 6 can be arranged on the heavy-duty transport vehicle 1 also in the region of its longitudinal sides 1a and can be moved transversely with respect to the longitudinal direction L between the loading position and the release position. Moreover, each guide 6 can be provided with a dedicated positioning apparatus 7, by means of which each guide 6 can be moved independently of the others between the loading position and the release position.

It is also fundamentally feasible to provide merely one guide 6 on the end side at one of the ends 1b and 1c which, with corresponding dimensioning, permits orientation of at least one head side 5b and one longitudinal side 5c of the second container 5, in order to guide the second container 5 during placement with the required level of accuracy onto the first container 5 and to secure it thereon. However, all four corner fittings 5a of the upper second container 5 are preferably guided and secured, for which reason one or two correspondingly dimensioned guides 6 are provided in each case at both ends 1a and 1b.

In addition, in order to be able to form and transport at least one double stack of 20 foot long containers 5, at least one guide 6 and one positioning apparatus 7 are also to be provided in the centre of the heavy-duty transport vehicle 1 and can be moved in a corresponding manner between a loading position and a release position. In the case of double stacks, the guide 6 and the positioning apparatus 7 are arranged accordingly between the two lower first containers 5, in order to be able to guide and secure the inner corner fittings 5a of the two upper second containers 5.

The heavy-duty transport vehicle 1 can also be operated manually or semi-automatically.

### LIST OF REFERENCE SIGNS

1 heavy-duty transport vehicle
1a longitudinal side
1b first end
1c is second end
2 vehicle frame
2a loading surface
2b guide element
2c storage surface
2d securing element
3a front axle
3b rear axle
4a front wheels
4b rear wheels
5 container
5a corner fitting
5b head side
5c longitudinal side
6 guide
6a first guide surface
6b second guide surface
6c insertion surface
6d stop
7 positioning apparatus
7a positioning arm
7b positioning drive
7c transverse beam
7d first limb
7e second limb
7f lifting cylinder
7g belt drive
7h linear guide
7i brace
7j drive lever
G1 first size
G2 second size
G3 third size
G4 fourth size
L longitudinal direction
P axis of oscillation
S swivel axis

1. A heavy-duty transport vehicle for containers that is freely movable on floors, and not rail-bound, having a loading surface on which a first container can be placed, wherein a second container can be placed on the first container, and wherein the heavy-duty transport vehicle has at least one guide configured to guide the second container when it is placed on the first container, wherein the guide is moved between a loading position and a release position by a moveable positioning apparatus.

2. The heavy-duty transport vehicle as claimed in claim 1, wherein in the loading position the guide is configured to lie against a top corner fitting of the first container, and in the release position the guide is arranged spaced apart from the first container, and wherein the guide is configured to guide a bottom corner fitting of the second container when it is placed on the first container.

3. The heavy duty transport vehicle as claimed in claim 1, wherein the guide is mounted on at least one positioning arm of the positioning apparatus, said positioning arm being mounted on the heavy-duty transport vehicle so as to be movable in a translatory or rotatory manner between the loading position and the release position.

4. The heavy-duty transport vehicle as claimed in claim 3, wherein the positioning apparatus has a positioning drive configured to move the positioning arm.

5. The heavy-duty transport vehicle as claimed in claim 4, wherein the positioning drive is designed as a linear drive and is arranged underneath the loading surface.

6. The heavy-duty transport vehicle as claimed in claim 1, wherein the guide has a first guide surface and a second guide surface, and wherein in the loading position the first guide surface lies against a head side of the first container and/or the second guide surface lies against a longitudinal side of the first container.

7. The heavy-duty transport vehicle as claimed in claim 6, wherein in the loading position the first guide surface and the second guide surface are configured to extend over the top corner fittings of the first container when placed on the loading surface, and wherein the first container is configured to have a height of 8 foot to 9 foot, 6 inches, and wherein in the loading position the first guide surface is oriented in parallel in relation to the head side and the second guide surface is oriented in parallel in relation to the longitudinal side.

8. The heavy-duty transport vehicle as claimed in claim 6, wherein an insertion surface adjoins in each case above the first guide surface and above the second guide surface and extends in the loading position in each case obliquely upwards and in a manner directed away from the first container.

9. The heavy-duty transport vehicle as claimed in claim 1, wherein each guide is mounted in a rotatable manner, in particular oscillating about an axis of oscillation oriented transversely with respect to a longitudinal direction of the heavy-duty transport vehicle, or in a rotationally fixed manner on the at least one positioning arm.

10. The heavy-duty transport vehicle as claimed in claim 9, wherein the guide is rotatably mounted such that the guide surfaces remain oriented vertically when the guide is moved from the loading position.

11. The heavy-duty transport vehicle as claimed in claim 9, wherein the guide has two stops in the region of the axis of oscillation, in order to limit oscillation of the guide about the axis of oscillation.

12. The heavy-duty transport vehicle as claimed in claim 1, wherein the at least one guide comprises two guides are arranged at a first end or arranged at a second end of the heavy-duty transport vehicle such that in the loading position in each case the guides lie against respective ones of two top corner fittings of either the first end or the second end of the first container.

13. The heavy-duty transport vehicle as claimed in claim 12, wherein the two guides are each connected to one another at the first end or are each connected to one another at the second end, and wherein the guides can be moved in a synchronized manner.

14. The heavy-duty transport vehicle as claimed in claim 12, wherein each guide is rotatably mounted on two positioning arms which are coupled to one another in the manner of a parallelogram guide and are mounted so as to be movable in a synchronized manner via a positioning drive.

15. The heavy-duty transport vehicle as claimed in claim 1, wherein the heavy-duty transport vehicle comprises an automated guided vehicle.

16. A method for loading a heavy-duty transport vehicle as claimed in claim 1, wherein in a first loading step a first container is placed on the loading surface, and wherein during the first loading step each guide is arranged in the release position and after the first container has been placed each guide is moved to the loading position.

17. The method as claimed in claim 16, wherein in a second loading step a second container is placed on the first container and in this case bottom corner fittings of the second container are guided via the at least one guide onto top corner fittings of the first container.

18. The heavy-duty transport vehicle as claimed in claim 12, wherein the two guides are arranged at the first end and are moveable by the positioning apparatus, and wherein the heavy-duty transport vehicle further includes two additional guides arranged at the second end and wherein the two additional guides are moveable by an additional positioning apparatus between a loading position and a release position, and wherein in the loading position each guide of the two additional guides lie against respective ones of two top corner fittings of the second end of the first container.

19. The heavy-duty transport vehicle as claimed in claim 18, wherein the two guides arranged at the first end are connected to one another so as to be moveable in a synchronized manner, and wherein the two additional guides arranged at the second end are connected to one another so as to be moveable in a synchronized manner.

20. The heavy-duty transport vehicle of claim 19, wherein the positioning apparatus comprises a first end positioning arm that is movable in a translatory or rotatory manner and wherein the two guides are joined with the first end positioning arm, and wherein the additional positioning apparatus comprises a second end positioning arm that is movable in a translatory or rotatory manner and wherein the two additional guides are joined with the second end positioning arm.
